(19) United States
(12) Patent Application Publication
(10) Pub. No.: US 2025/0354681 A1
(43) Pub. Date: Nov. 20, 2025

(54) LIGHT STRING POWER SUPPLY

(71) Applicant: NINGBO GOLDEN POWER ELECTRONIC CO., LTD., Ningbo (CN)

(72) Inventor: Yongxing HUANG, Ningbo (CN)

(73) Assignee: NINGBO GOLDEN POWER ELECTRONIC CO., LTD., Ningbo (CN)

(21) Appl. No.: 19/212,784

(22) Filed: May 20, 2025

(30) Foreign Application Priority Data
May 20, 2024 (CN) 202421097623.0

(51) Int. Cl. F21V 23/02; F21V 23/04

(52) U.S. Cl. CPC F21V 23/023; F21V 23/04

(57) ABSTRACT

A light string power supply includes a housing, an end cover, and a circuit board, where the end cover is fixed to an open end of the housing; the circuit board is disposed inside the housing; the end cover is embedded with a button for triggering a key located on the circuit board; the light string power supply further includes a push rod; a shell of the key is provided with a first annular boss; a triggering end of the key is located inside the first annular boss; one end of the push rod is connected to an inner end of the button, and the other end of the push rod is inserted into the first annular boss and abuts against the triggering end; and when the button is pressed, the push rod pushes the triggering end to trigger the key.

### CROSS REFERENCE TO THE RELATED APPLICATIONS

This application is based upon and claims priority to Chinese Patent Application No. 202421097623.0, filed on May 20, 2024, the entire contents of which are incorporated herein by reference.

### TECHNICAL FIELD

The present invention relates to the technical field of light string power supply devices, and in particular to a light string power supply.

### BACKGROUND

A light string power supply is used to supply power to light strings and control their on/off status and illumination modes. At present, the commercially available light string power supply includes a housing, an end cover, and a circuit board. The end cover is fixed to the open end of the housing, the circuit board is disposed inside the housing, and the end cover is embedded with a button for triggering the key located on the circuit board. When the button is pressed, the button triggers the key. Thus, the light string power supply can control the on/off status and illumination mode of the light string. However, in the commercially available light string power supply, the key disposed on the circuit board is either a push rod-type key or a surface-mounted key. During dip soldering between the key and the circuit board in the solder bath, the solder material tends to enter the key from the triggering end of the key, thereby causing key failure. Additionally, misalignment often occurs between the triggering end of the key and the button during assembly of the end cover and the housing, thereby leading to key failure.

### SUMMARY

A technical problem to be solved by the present invention is to provide a light string power supply. The present invention can prevent a solder material from entering a key and ensure reliable triggering of a triggering end of the key by a button, thereby effectively avoiding key failure.

The present invention provides a light string power supply, including a housing, an end cover, and a circuit board, where the end cover is fixed to an open end of the housing; the circuit board is disposed inside the housing; the end cover is embedded with a button for triggering a key located on the circuit board; the light string power supply further includes a push rod; a shell of the key is provided with a first annular boss; a triggering end of the key is located inside the first annular boss; one end of the push rod is connected to an inner end of the button, and the other end of the push rod is inserted into the first annular boss and abuts against the triggering end; and when the button is pressed, the push rod pushes the triggering end to trigger the key.

In the present invention, with this structure, when the key and circuit board undergo dip soldering in a solder bath, the first annular boss can reliably prevent the solder material from entering the key, thereby effectively preventing key failure. Additionally, since the other end of the push rod is inserted into the first annular boss and abuts against the triggering end of the key, the push rod and the key are restricted. In this way, when the button is pressed, the push rod can reliably trigger the triggering end of the key, thereby effectively avoiding key failure.

In a possible implementation, a second annular boss is provided at the inner end of the button, and the one end of the push rod is inserted into the second annular boss. With this structure, the one end of the push rod is conveniently inserted into the inner end of the button.

In a possible implementation, an outer sidewall of the one end of the push rod is attached to an inner sidewall of the second annular boss. With this structure, reliability of the connection between the one end of the push rod and the button is enhanced. After the connection between the one end of the push rod and the button is completed, accidental detachment of the push rod from the button is prevented during assembly of the end cover and the housing.

In a possible implementation, an annular chamfered surface is provided on an outer sidewall of each of the two ends of the push rod; the annular chamfered surface located on the outer sidewall of the one end of the push rod is configured to cooperate with the inner sidewall of the second annular boss for guiding to facilitate insertion of the one end of the push rod into the second annular boss; and the annular chamfered surface located on the outer sidewall of the other end of the push rod is configured to cooperate with an inner sidewall of the first annular boss for guiding to facilitate insertion of the other end of the push rod into the first annular boss. With this structure, when the one end of the push rod is connected to the button, the annular chamfered surface on the outer sidewall of the one end of the push rod is able to cooperate with the inner sidewall of the second annular boss for guiding to facilitate insertion of the one end of the push rod into the second annular boss. This facilitates assembly between the one end of the push rod and the button. When the other end of the push rod is connected to the key, the annular chamfered surface on the outer sidewall of the other end of the push rod is able to cooperate with the inner sidewall of the first annular boss for guiding to facilitate insertion of the other end of the push rod into the first annular boss. This facilitates assembly between the other end of the push rod and the key. Additionally, since the annular chamfered surfaces are provided on the outer sidewalls of the two ends of the push rod, the two ends of the push rod are made interchangeable. This increases flexibility in connections between the push rod and the button and the key. Specifically, during assembly of the push rod with the button and the key, there is no need to distinguish between the two ends of the push rod, thereby facilitating assembly of the push rod with the button and the key.

In a possible implementation, a protrusion is provided at a central portion of each of the two ends of the push rod; a recess is provided at the inner end of the button; and the protrusion located at the one end of the push rod is engaged with the recess, and the protrusion located at the other end of the push rod abuts against the triggering end. With this structure, the protrusion at the one end of the push rod is engaged with the recess, thereby ensuring more reliable positioning between the one end of the push rod and the button. Since the protrusion at the other end of the push rod abuts against the triggering end, the push rod can more reliably push the triggering end to trigger the key when the button is pressed. Additionally, since the protrusions are provided at the central portions of the two ends of the push rod, the two ends of the push rod are made interchangeable. This increases flexibility in connections between the push rod and the button and the key. Specifically, during assembly of the push rod with the button and the key, there is no need to distinguish between the two ends of the push rod, thereby facilitating assembly of the push rod with the button and the key.

In a possible implementation, an outer peripheral wall of the button is bonded and fixed to the end cover with circumferential sealing. With this structure, the button is reliably fixed to the end cover with circumferential sealing, and the fixation between the button and the end cover is easy. Furthermore, since the button and the end cover are circumferentially sealed, rainwater is prevented from entering the light string power supply through a gap between the button and the end cover, achieving waterproofing.

### BRIEF DESCRIPTION OF THE DRAWINGS

FIG. 1 is a three-dimensional structural schematic diagram according to the present invention;

FIG. 2 is a cross-sectional structural schematic diagram according to the present invention; and

FIG. 3 is an enlarged view of the structure circled in A shown in FIG. 2.

### DETAILED DESCRIPTION OF THE EMBODIMENTS

Firstly, those skilled in the art should understand that the implementations herein are merely intended to explain the technical principles of the embodiments in the present application, rather than to limit the protection scope of the embodiments in the present application. Those skilled in the art can make adjustments to the implementations as needed in order to adapt to specific application scenarios.

In the description of the embodiments of the present application, it should be noted that, unless otherwise clearly specified, meanings of terms “connected with”, and “connected to” should be understood in a broad sense. For example, the connection may be a fixed connection, a removable connection, an integral connection, a mechanical connection, an electrical connection, a direct connection or an indirect connection through a medium. Those of ordinary skill in the art may understand specific meanings of the foregoing terms in the embodiments of the present application based on a specific situation.

In the embodiments of the present application, unless otherwise explicitly specified, when it is described that a first feature is “above” or “below” a second feature, it indicates that the first and second features are in direct contact or the first and second features are in indirect contact through an intermediate feature. In addition, when it is described that the first feature is “over”, “above” and “on” the second feature, it indicates that the first feature is directly or obliquely above the second feature, or simply indicates that an altitude of the first feature is higher than that of the second feature. When it is described that the first feature is “under”, “below” or “beneath” the second feature, it indicates that the first feature is directly or obliquely under the second feature or simply indicates that an altitude of the first feature is lower than that of the second feature.

The present application will be further described in detail below in conjunction with the drawings and specific embodiments.

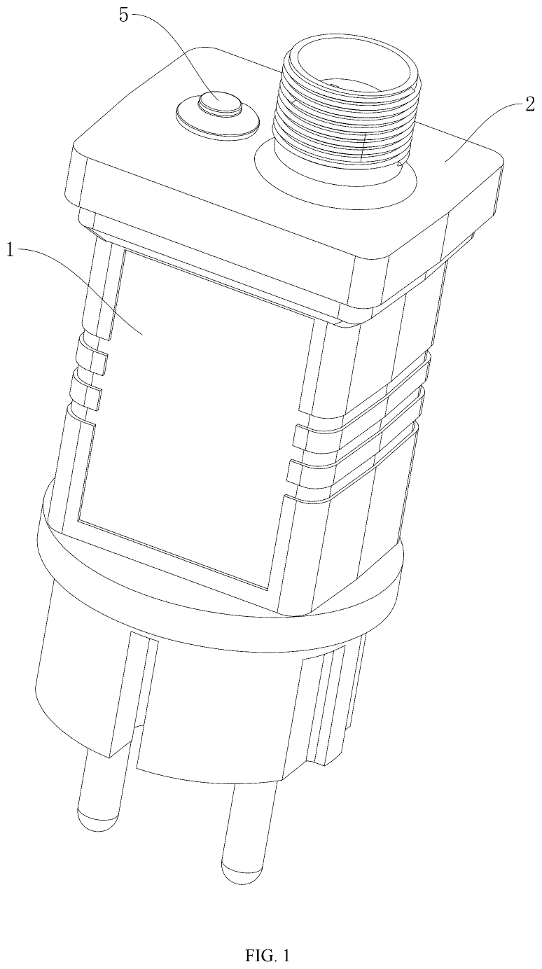

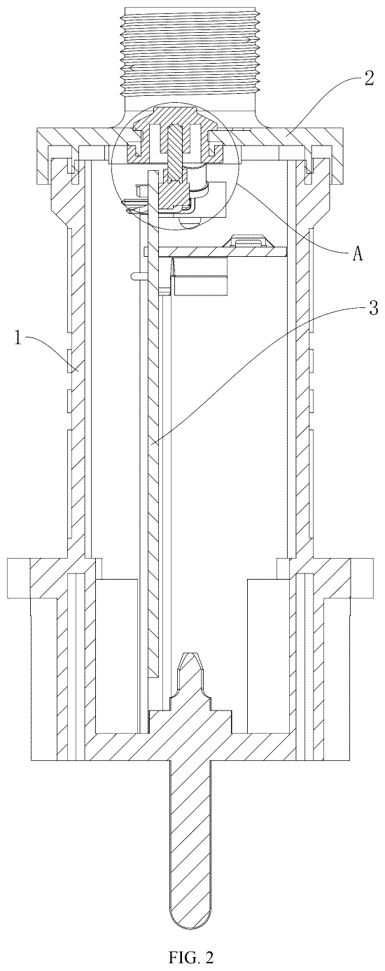

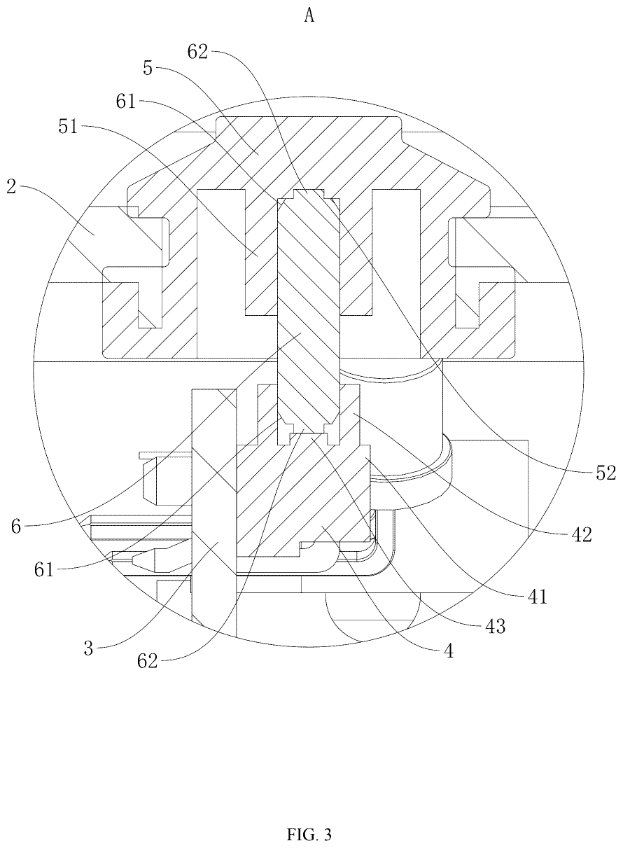

Referring to FIGS. 1 to 3, an embodiment of the present application provides a light string power supply, including housing 1, end cover 2, and circuit board 3. The end cover 2 is fixed to an open end of the housing 1. The circuit board 3 is disposed inside the housing 1. The end cover 2 is embedded with button 5 for triggering key 4 located on the circuit board 3. The light string power supply further includes push rod 6. Shell 41 of the key 4 is provided with first annular boss 42. Triggering end 43 of the key 4 is located inside the first annular boss 42. One end of the push rod 6 is connected to an inner end of the button 5, and the other end of the push rod 6 is inserted into the first annular boss 42 and abuts against the triggering end 43. When the button 5 is pressed, the push rod 6 pushes the triggering end 43 to trigger the key 4. The button is made of a silicone material.

Second annular boss 51 is provided at the inner end of the button 5. The one end of the push rod 6 is inserted into the second annular boss 51. With this structure, the one end of the push rod is conveniently inserted into the inner end of the button.

An outer sidewall of the one end of the push rod 6 is attached to an inner sidewall of the second annular boss 51. With this structure, reliability of the connection between the one end of the push rod and the button is enhanced. After the connection between the one end of the push rod and the button is completed, accidental detachment of the push rod from the button is prevented during assembly of the end cover and the housing.

Annular chamfered surface 61 is provided on an outer sidewall of each of the two ends of the push rod 6. The annular chamfered surface 61 located on the outer sidewall of the one end of the push rod 6 is configured to cooperate with the inner sidewall of the second annular boss 51 for guiding to facilitate insertion of the one end of the push rod 6 into the second annular boss 51. The annular chamfered surface 61 located on the outer sidewall of the other end of the push rod 6 is configured to cooperate with an inner sidewall of the first annular boss 42 for guiding to facilitate insertion of the other end of the push rod 6 into the first annular boss 42. With this structure, when the one end of the push rod is connected to the button, the annular chamfered surface on the outer sidewall of the one end of the push rod is able to cooperate with the inner sidewall of the second annular boss for guiding to facilitate insertion of the one end of the push rod into the second annular boss. This facilitates assembly between the one end of the push rod and the button. When the other end of the push rod is connected to the key, the annular chamfered surface on the outer sidewall of the other end of the push rod is able to cooperate with the inner sidewall of the first annular boss for guiding to facilitate insertion of the other end of the push rod into the first annular boss. This facilitates assembly between the other end of the push rod and the key. Additionally, since the annular chamfered surfaces are provided on the outer sidewalls of the two ends of the push rod, the two ends of the push rod are made interchangeable. This increases flexibility in connections between the push rod and the button and the key. Specifically, during assembly of the push rod with the button and the key, there is no need to distinguish between the two ends of the push rod, thereby facilitating assembly of the push rod with the button and the key.

Protrusion 62 is provided at a central portion of each of the two ends of the push rod 6. Recess 52 is provided at the inner end of the button 5. The protrusion 62 located at the one end of the push rod 6 is engaged with the recess 52, and the protrusion 62 located at the other end of the push rod 6 abuts against the triggering end 43. With this structure, the protrusion at the one end of the push rod is engaged with the recess, thereby ensuring more reliable positioning between the one end of the push rod and the button. Since the protrusion at the other end of the push rod abuts against the triggering end, the push rod can more reliably push the triggering end to trigger the key when the button is pressed. Additionally, since the protrusions are provided at the central portions of the two ends of the push rod, the two ends of the push rod are made interchangeable. This increases flexibility in connections between the push rod and the button and the key. Specifically, during assembly of the push rod with the button and the key, there is no need to distinguish between the two ends of the push rod, thereby facilitating assembly of the push rod with the button and the key.

An outer peripheral wall of the button 5 is bonded and fixed to the end cover 2 with circumferential sealing. With this structure, the button is reliably fixed to the end cover with circumferential sealing, and the fixation between the button and the end cover is easy. Furthermore, since the button and the end cover are circumferentially sealed, rainwater is prevented from entering the light string power supply through a gap between the button and the end cover, achieving waterproofing.

The above described are merely specific implementations of the present application, and are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A light string power supply, comprising a housing, an end cover, a circuit board, and a push rod, wherein the end cover is fixed to an open end of the housing; the circuit board is disposed inside the housing; the end cover is embedded with a button for triggering a key located on the circuit board; a shell of the key is provided with a first annular boss; a triggering end of the key is located inside the first annular boss; a first end of the push rod is connected to an inner end of the button, and a second end of the push rod is inserted into the first annular boss and abuts against the triggering end; and when the button is pressed, the push rod pushes the triggering end to trigger the key.

2. The light string power supply according to claim 1, wherein a second annular boss is provided at the inner end of the button, and the first end of the push rod is inserted into the second annular boss.

3. The light string power supply according to claim 2, wherein an outer sidewall of the first end of the push rod is attached to an inner sidewall of the second annular boss.

4. The light string power supply according to claim 2, wherein a first annular chamfered surface and a second annular chamfered surface are respectively provided on the outer sidewall of the first end and an outer sidewall of the second end of the push rod; the first annular chamfered surface located on the outer sidewall of the first end of the push rod is configured to cooperate with the inner sidewall of the second annular boss for guiding to facilitate insertion of the first end of the push rod into the second annular boss; and the second annular chamfered surface located on the outer sidewall of the second end of the push rod is configured to cooperate with an inner sidewall of the first annular boss for guiding to facilitate insertion of the second end of the push rod into the first annular boss.

5. The light string power supply according to claim 4, wherein a first protrusion and a second protrusion are respectively provided at a central portion of the first end and a central portion of the second end of the push rod; a recess is provided at the inner end of the button; and the first protrusion located at the first end of the push rod is engaged with the recess, and the second protrusion located at the second end of the push rod abuts against the triggering end.

6. The light string power supply according to claim 1, wherein an outer peripheral wall of the button is bonded and fixed to the end cover with circumferential sealing.

7. The light string power supply according to claim 3, wherein a first annular chamfered surface and a second annular chamfered surface are respectively provided on the outer sidewall of the first end and an outer sidewall of the second end of the push rod; the first annular chamfered surface located on the outer sidewall of the first end of the push rod is configured to cooperate with the inner sidewall of the second annular boss for guiding to facilitate insertion of the first end of the push rod into the second annular boss; and the second annular chamfered surface located on the outer sidewall of the second end of the push rod is configured to cooperate with an inner sidewall of the first annular boss for guiding to facilitate insertion of the second end of the push rod into the first annular boss.

8. The light string power supply according to claim 2, wherein an outer peripheral wall of the button is bonded and fixed to the end cover with circumferential sealing.

9. The light string power supply according to claim 3, wherein an outer peripheral wall of the button is bonded and fixed to the end cover with circumferential sealing.

10. The light string power supply according to claim 4, wherein an outer peripheral wall of the button is bonded and fixed to the end cover with circumferential sealing.

11. The light string power supply according to claim 7, wherein a first protrusion and a second protrusion are respectively provided at a central portion of the first end and a central portion of the second end of the push rod; a recess is provided at the inner end of the button; and the first protrusion located at the first end of the push rod is engaged with the recess, and the second protrusion located at the second end of the push rod abuts against the triggering end.

12. The light string power supply according to claim 11, wherein an outer peripheral wall of the button is bonded and fixed to the end cover with circumferential sealing.
